(19) United States
(12) Patent Application Publication
(10) Pub. No.: US 2017/0349192 A1
(43) Pub. Date: Dec. 7, 2017

(54) Railroad Sign Fastener

(71) Applicant: Douglas Murdaugh, Tinley Park, IL (US)

(72) Inventor: Douglas Murdaugh, Tinley Park, IL (US)

(21) Appl. No.: 15/610,739

(22) Filed: Jun. 1, 2017

Related U.S. Application Data
(60) Provisional application No. 62/343,966, filed on Jun. 1, 2016.

(51) Int. Cl. B61L 5/12; G09F 7/18

(52) U.S. Cl. CPC B61L 5/12; G09F 7/18; G09F 2007/1804; G09F 2007/1873; G09F 2007/1856

(57) ABSTRACT

A railroad sign holder. The railroad sign holder provides a device for securing to a rail to display a signage member to oncoming trains and surrounding individuals. The railroad sign holder has a rod member, and a base member, the base member including an elongated section. The rod member has a signage member. The elongated section includes a rail clamp configured to removably affix to a rail. The rail clamp has a first arm and a second arm, each arm slidably disposed to a clamp bolt. Each of the first arm and the second arm includes a channel, the channel of the first arm facing the channel of the second arm. Each of the channels configured to receive a flange of the rail.

### CROSS REFERENCE TO RELATED APPLICATIONS

This application claims the benefit of U.S. Provisional Application No. 62/343,966 filed on Jun. 1, 2016. The above identified patent application is herein incorporated by reference in its entirety to provide continuity of disclosure.

### BACKGROUND OF THE INVENTION

The present invention relates to railroad sign holders.

The conventional method of mounting a sign near a railroad track involves digging a hole and planting the sign in the ground. However, when railroad tracks are being laid the ground beneath and around the tracks is typically compacted to prevent shifting under the weight of a train or during minor earthquakes. As a result, compacted ground is difficult to dig through by hand and machinery is often not able to reach the area due to topographical and vegetative difficulties. It can take a substantial amount of time for workers to dig through by hand and could require the use of drills, sledgehammers, and jackhammers if the ground is rocky.

Furthermore, while crews are clearing a path for a train track they often also take advantage of the construction and clearing to lay piping and wiring. A hole being dug could result in accidentally severing piping and wiring. Severing a ground wire could shut down that rail line for hours until the wiring can be patched. After the sign is removed the hole creates a tripping hazard that may injure future workers and as such then requires the workers to refill the hole and subsequently compact the fill. Therefore, it is desirable to have a device by which a sign can be installed along a rail road without the digging of a hole.

### SUMMARY OF THE INVENTION

In view of the foregoing disadvantages inherent in the known types of railroad sign holders now present in the known art, the present invention provides a railroad sign holder comprising a rod member, and a base member, the base member including an elongated section. The rod member comprising a signage member. The elongated section comprising a rail clamp configured to removably affix to a rail. The rail clamp comprising a first arm and a second arm, each arm slidably disposed to a clamp bolt. Each of the first arm and the second arm includes a channel, the channel of the first arm facing the channel of the second arm. Each of the channels configured to receive a flange of the rail wherein the same can be utilized for providing convenience for the user when the user needs to install a sign along a railroad.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of an embodiment of the railroad sign holder.

FIG. 2 shows a close-up view of an embodiment of the railroad sign holder.

FIG. 3 shows an alternate perspective view of an embodiment of the railroad sign holder.

### DETAILED DESCRIPTION OF THE INVENTION

Reference is made herein to the attached drawings. Like reference numerals are used throughout the drawings to depict like or similar elements of the railroad sign holder. The figures are intended for representative purposes only and should not be considered to be limiting in any respect. Unless specifically limited to a single unit, “a” is intended to be equivalent to “one or more” throughout the present disclosure.

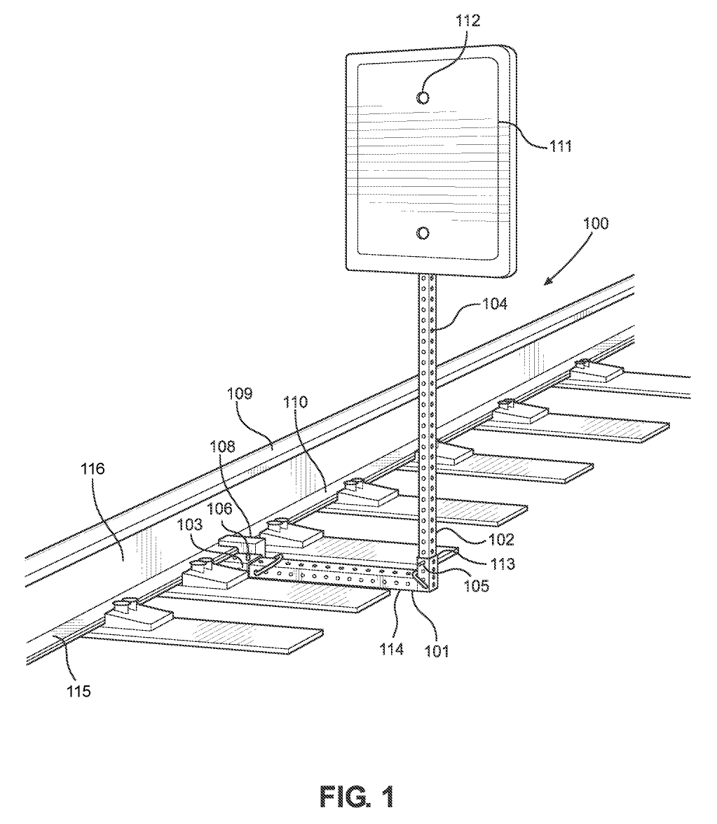

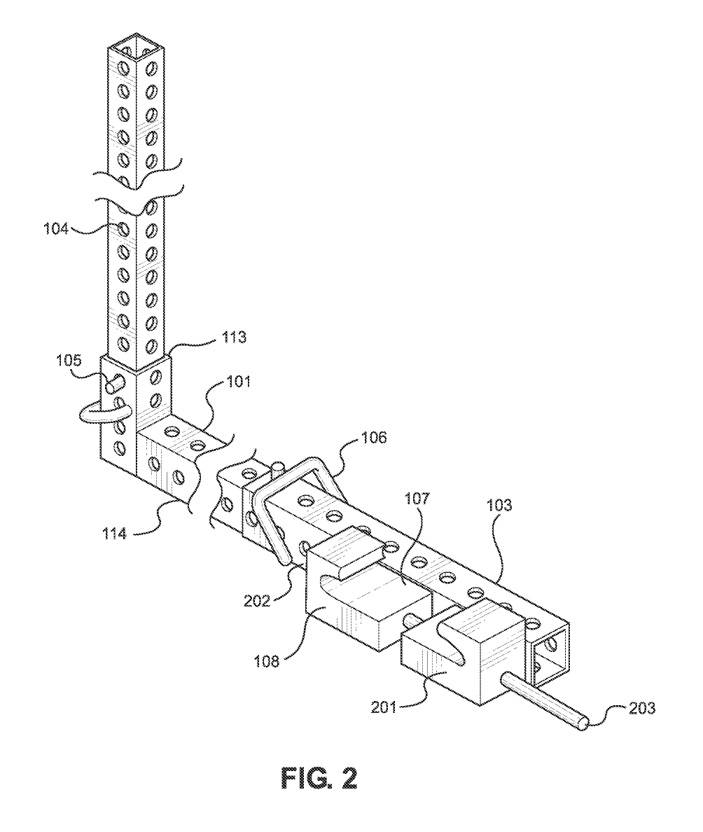

Referring now to FIGS. 1 and 2, there is shown a perspective view of an embodiment of the railroad sign holder, and a close-up view of an embodiment of the railroad sign holder, respectively. The railroad sign holder 100 provides a device for securing to a rail to display a signage member to oncoming trains and surrounding individuals. The railroad sign holder 100 comprises a rod member 102 and a base member 101, wherein the base member includes an elongated section 114. In the shown embodiment, the rod member 102 and a base member 101 are removably affixed. However, in alternative embodiments, the rod member 102 and a base member 101 are of unitary construction. The elongated section 114 comprising a rail clamp 103 configured to removably affix to a rail 109, such as a train rail. The rail clamp 103 includes a first arm 201 and a second arm 108, wherein the arms 201, 108 are slidably disposed to a clamp bolt 203. The clamp bolt 203 is configured to allow each arm 201, 108 to adjust a distance therebetween. Each of the first arm 201 and the second arm 108 includes a channel 107, wherein the channel 107 of the first arm 201 faces the channel 107 of the second arm 108. Each of the channels 107 are configured to receive a flange 110 of the rail. In this way, the railroad side fastener 100 may be selectively positioned on opposing sides of a rail 109 such that the channels 107 of the arms 201, 108 clamp to the rail 109. Thus, the base member 101 causes the rod member 104 to be oriented upright from the ground and laterally offset from rail 109.

In the shown embodiment, the rod member 102 is removably affixed to a receiving section 113 of the base member 101, wherein the receiving section 113 is configured to slidably engage the rod member 102. Furthermore, the rail clamp 103 is removably affixed to the base member 101, wherein the rail clamp 103 is configured to slidably engage the base member 101. The shown configuration allows the rail clamp 103 to be adjustably secured to the base member 101 so as to allow the rail clamp 103 to extend into an extended configuration, and retract into a retracted configuration. This telescopic arrangement of the rail clamp 103 and the base member 101 provides for adjustment of the length of the railroad sign holder 100.

The rod member 102 is configured to affix a signage member 111 thereto. The shown configuration also allows the rod member 102 to be adjustably secured to the base member 101 so as to allow the rod member 102 to extend into an extended configuration, and retract into a retracted configuration. This telescopic arrangement of the rod member 102 and the base member 101 provides for adjustment of the height of the railroad sign holder 100. In some embodiments, the rod member 102, the base member 101, and the rail clamp 103 are a single contiguous piece and in other embodiments they are a plurality of pieces. In the shown embodiment, the elongated section is disposed perpendicular to the rod member whereas in other embodiments other angles are used.

In the shown embodiment, the base member 101, the rod member 102, and the rail clamp 103 are hollow tubular members with a square cross-section. In other embodiments, the base member 101, the rod member 102, and the rail clamp 103 are made in any suitable shape, with and without a plurality of apertures 104. The base member 101, the rod member 102, and the rail clamp 103 each comprise a plurality of apertures 104 disposed at intervals therealong. In one embodiment, the plurality of apertures 104 are identically sized and are disposed throughout the length of and on every side of the base member 101, the rod member 102, and the rail clamp 103. In other embodiments, the plurality of apertures 103 differ in number, spacing and size.

In the illustrated embodiment, a pin 105 is configured to fasten the base member 101 to the rod member 102 via selectively inserting the pin 105 into a first pair of aligned apertures of the plurality of apertures 104 thereby allowing a user to select the desired height of the railroad sign holder 100. Another pin 106 is configured to fasten the base member 101 to the rail clamp 103 via selectively inserting the pin 105 into a first pair of aligned apertures of the plurality of apertures 104 thereby allowing a user to select the desired length of the railroad sign holder 100. The pins 105, 106 are configured such that they will not fall out from the vibrations of a passing train. In other embodiments, other numbers of pins 105 106 are used. In yet other embodiments, the base member 101, the rod member 102, and the rail clamp 103, are fastened to one another via any suitable fastener.

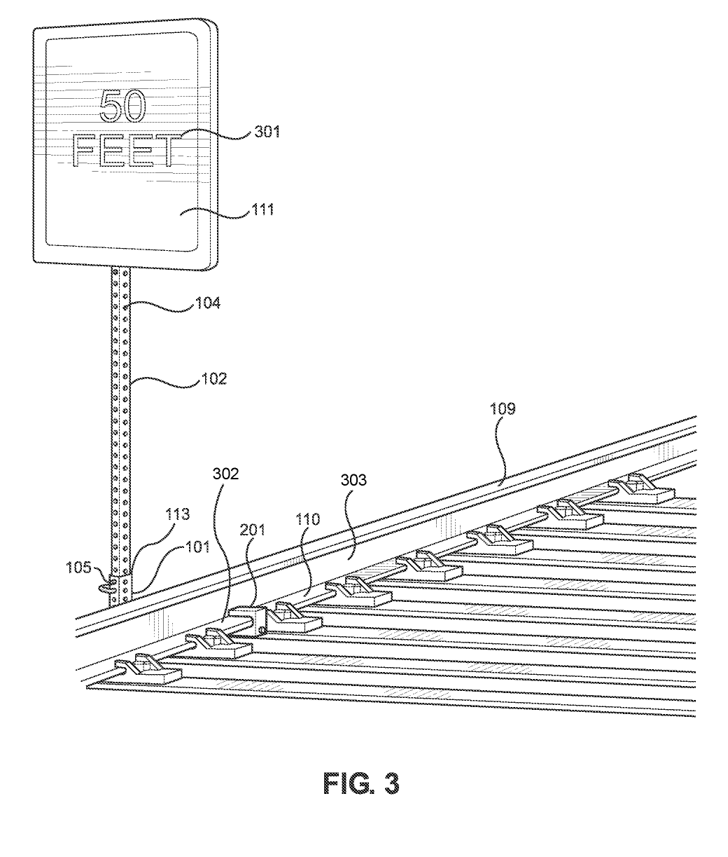

Referring now to FIGS. 1 and 3, there is shown a perspective view of an embodiment of the railroad sign holder, and an alternate perspective view of an embodiment of the railroad sign holder, respectively. In the shown embodiment, the first arm 201 is fixed and the second arm 108 is slidably adjustable along the clamp bolt. The channel 107 of the first arm 201 is configured to receive a first flange 115 disposed on a first side 116 of the rail 109, and the channel 107 of the second arm 108 is configured to receive a second flange 302 disposed on an opposing side 303 of the rail 109. The clamp bolt in the shown embodiment is disposed along a lateral side of the rail clamp 103 such that the signage member 111 is in an upright position. In other embodiments, the clamp bolt is in other relative positions compared to the rail clamp 103 such as being disposed along an upper side of the rail clamp 103.

In the shown embodiment, the signage member 111 includes a first face 301 having indicia thereon, the indicia configured to provide railroad signaling aspects and indications. In some embodiments, the signage member has a plurality of faces. In some embodiments, the indicia are words or symbols. In other embodiments, the indicia are lights. In yet other embodiments, other suitable types of indicia are used.

In use the shown embodiment of the railroad sign holder 100 is installed by transporting the base member 101, rod member 102 and rail clamp 103 along with the pins 105, 106 to the designated site. There the user clears some space beneath the rail 109 and inserts the base member 101 into the rail clamp 103. Thereafter the user secures the base member 101 to the rail clamp 103 using a pin 106. After being joined the elongated section 114 is extended under the rail 109 and subsequently the rail clamp 103 is attached to the flange 110 of the rail 109. The rod member 102 is then slid into the base member 101 and secured using a pin 105. The cleared dirt and rocks are replaced around the base member 101 and rail clamp 103.

It is therefore submitted that the instant invention has been shown and described in various embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A railroad sign holder, comprising:
a rod member and a base member, the base member including an elongated section extending at an angle from the rod member;
the rod member configured to affixed a signage member thereto;
the elongated section comprising a rail clamp configured to removably affix to a rail;
the rail clamp comprising a first arm and a second arm, each arm disposed to a clamp bolt; and
wherein each of the first arm and the second arm includes a channel, the channel of the first arm facing the channel of the second arm, each of the channels configured to receive a flange of the rail.

2. The railroad sign holder of claim 1, wherein the rod member is removably affixed to a receiving section of the base member, wherein the receiving section is configured to slidably engage the rod member.

3. The railroad sign holder of claim 1, wherein the rail clamp is removably affixed to the base member, wherein the rail clamp is configured to slidably engage the base member.

4. The railroad sign holder of claim 1, wherein the elongated section is disposed perpendicular to the rod member.

5. The railroad sign holder of claim 1, wherein the first arm is fixed and the second arm is slidably adjustable along the clamp bolt.

6. The railroad sign holder of claim 1, wherein the channel of the first arm is configured to receive a first flange disposed on a first side of the rail, and the channel of the second arm is configured to receive a second flange disposed on an opposing side of the rail.

7. The railroad sign holder of claim 1, wherein the signage member includes a first face having indicia thereon, the indicia configured to provide railroad signaling aspects and indications.

8. The railroad sign holder of claim 1, wherein the signage member is removably affixed to the rod member via a fastener.

9. The railroad sign holder of claim 1, wherein the base member, the rod member, and the rail clamp each comprise hollow tubular members having a square cross-section.

10. The railroad sign holder of claim 1, wherein the base member, the rod member, and the rail clamp each comprise a plurality of apertures disposed at intervals therealong.

11. The railroad sign holder of claim 10, wherein a pin is configured to fasten the base member to the rod member via selectively inserting the pin into a first pair of aligned apertures of the plurality of apertures.

12. The railroad sign holder of claim 10, wherein the pin is configured to fasten the base member to the rail clamp via selectively inserting the pin into a second pair of aligned apertures of the plurality of apertures.

13. The railroad sign holder of claim 1, wherein the clamp bolt is disposed along a lateral side of the rail clamp such that the signage member is in an upright position.
